(19) United States
(12) Patent Application Publication
(10) Pub. No.: US 2007/0271513 A1
(43) Pub. Date: Nov. 22, 2007

(54) User Interface for Remotely Controlling a Digital Music Player

(75) Inventor: Bo Stefan Andren, Portland, OR (US)

Correspondence Address: BANNER & WITCOFF, LTD., 1100 13th STREET, N.W., SUITE 1200, WASHINGTON, DC, 20005-4051, US

(73) Assignee: NIKE, INC., Beaverton, OR (US)

(21) Appl. No.: 11/751,873

(22) Filed: May 22, 2007

Related U.S. Application Data
(60) Provisional application No. 60/802,636, filed on May 22, 2006.

(51) Int. Cl. G06F 3/00

(52) U.S. Cl. 715/703

(57) ABSTRACT

Methods and systems for remotely controlling operation of a digital media player are described herein. A wristwatch or other alternatively-purposed device may incorporate a transceiver for communicating with a digital media player. A user may interact with the wristwatch using a plurality of buttons disposed about a housing of the watch, through which the user may adjust a volume level of the digital media player, navigate audio playback, power the digital media player on and off, request playback of a song previously identified by the user, and adjust settings of the wristwatch. The wristwatch and/or the digital media player may be in communication with a biological performance measurement device, and the user, via the wristwatch, may request playback of a biological performance measurement recorded by the biological performance measurement device.

### CROSS-REFERENCE TO RELATED APPLICATIONS

The present application is a non-provisional application based on and claiming priority to provisional application Ser. No. 60/802,636, filed May 22, 2006, having the first named inventor Stefan Andren and attorney docket number 005127.00649.

### FIELD OF THE INVENTION

The present invention relates generally to user interfaces on consumer electronic devices. More specifically, the invention relates to a user interface for remotely controlling a digital media player, such as a media player that plays MP3, ACC, or other audio files. Various examples of the invention are particularly applicable for use with a watch that remotely controls a digital media player.

### BACKGROUND OF THE INVENTION

Digital media players, such as music players that play back sound files stored in an electronic storage medium, are becoming ubiquitous. Because of their portability, many people listen to music or other recordings while performing some type of physical activity, such as jogging or exercising. While the small form factor of digital media players allows them to be easily carried while performing a physical activity, that same small form factor often makes them difficult to control during such physical activity due to the fine motor skills required to control most digital media players. That is, while performing a physical activity such as jogging, it becomes more difficult to use the fine motor skills necessary to control a digital media player.

### BRIEF SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

To overcome limitations in the prior art described above, and to overcome other limitations that will be apparent upon reading and understanding the present specification, aspects of the present invention are directed to a remote control device for controlling a digital media player. Some implementations may be used on a watch or similar alternately-purposed device configured to control a digital music player in addition to performing other functions. A wristwatch or other alternatively-purposed device may incorporate a transceiver for communicating with the digital media player.

A user may interact with the wristwatch using a plurality of buttons disposed about a housing of the watch, through which the user may adjust a volume level of the digital media player, navigate audio playback, power the digital media player on and off, request playback of a song previously identified by the user, and adjust settings of the wristwatch. The wristwatch and/or the digital media player may be in communication with a biological performance measurement device, and the user, via the wristwatch, may request playback of a biological performance measurement recorded by the biological performance measurement device.

Methods and systems may encompass a device (e.g., a watch) having a device housing configured to be worn by a human user, a display providing visual output of the device, an input subsystem comprising a plurality of input buttons, a transceiver for communicating with a digital media player based on input received from a user via the plurality of buttons, and a processor for controlling overall operation of the device based on stored control logic. The control logic may indicate that the device, upon detecting a brief press of a first button of the plurality of input buttons, sends a play/pause toggle command to the digital media player. The device, upon detecting a brief press of a second button of the plurality of input buttons, sends a command to the digital media player to skip to a next audio file. The device, upon detecting a long press of the second button, sends a command to the digital media player to fast forward a currently playing audio file. The device, upon detecting a brief press of a third button of the plurality of input buttons, sends a command to the digital media player to skip to a previous audio file. The device, upon detecting a long press of the third button, sends a command to the digital media player to rewind a currently playing audio file. The device, upon detecting a brief press of a fourth button of the plurality of input buttons, sends a command to the digital media player to increment a volume up one step. The device, upon detecting a long press of the fourth button, sends a command to the digital media player to scroll volume up while the fourth button remains in a depressed state.

The device, upon detecting a brief press of a fifth button of the plurality of input buttons, sends a command to the digital media player to decrement a volume down one step. The device, upon detecting a long press of the fifth button, sends a command to the digital media player to scroll volume down while the fifth button remains in a depressed state.

### BRIEF DESCRIPTION OF THE DRAWINGS

FIG. 1 illustrates a watch according to an illustrative embodiment of the invention.

FIG. 2 illustrates a control flow for controlling the operation of a watch and a remote digital music player according to an illustrative aspect described herein.

FIG. 3 illustrates a feedback/PowerPlay control flow for controlling the operation of a watch and a remote digital music player according to an illustrative aspect described herein.

FIG. 4 illustrates a volume control flow for controlling the operation of a watch and a remote digital music player according to an illustrative aspect described herein.

FIG. 5 illustrates a track change control flow for controlling the operation of a watch and a remote digital music player according to an illustrative aspect described herein.

FIG. 6 illustrates a track change control flow for controlling the operation of a watch and a remote digital music player according to an illustrative aspect described herein.

FIG. 7 illustrates a play/pause/power control flow for controlling the operation of a watch and a remote digital music player according to an illustrative aspect described herein.

FIGS. 8 and 9 illustrates an adjust mode control flow for controlling the operation of a watch and a remote digital music player according to an illustrative aspect described herein.

FIGS. 10-12 illustrate animations that may be displayed by a watch while controlling a remote digital music player according to an illustrative aspect described herein.

FIG. 13 illustrates a multi-button control flow for controlling the operation of a watch and a remote digital music player according to an illustrative aspect described herein.

FIG. 14 illustrates a demo mode animation according to an illustrative aspect described herein.

FIG. 15 illustrates a wake up animation according to an illustrative aspect described herein.

FIG. 16 illustrates a watch according to an illustrative embodiment of the invention.

FIG. 17 illustrates a volume control flow for controlling the operation of a watch and a remote digital music player according to an illustrative aspect described herein.

FIG. 18 illustrates a track control flow for controlling the operation of a watch and a remote digital music player according to an illustrative aspect described herein.

FIG. 19 illustrates a track control flow for controlling the operation of a watch and a remote digital music player according to an illustrative aspect described herein.

FIG. 20 illustrates a feedback/PowerPlay control flow for controlling the operation of a watch and a remote digital music player according to an illustrative aspect described herein.

FIG. 21 illustrates a play/pause/power control flow for controlling the operation of a watch and a remote digital music player according to an illustrative aspect described herein.

FIG. 22 illustrates an adjust mode control flow for controlling the operation of a watch and a remote digital music player according to an illustrative aspect described herein.

FIG. 23 illustrates a sport mode control flow for controlling the operation of a watch and a remote digital music player according to an illustrative aspect described herein.

FIG. 24 illustrates a block hardware diagram of a watch according to one or more illustrative aspects described herein.

### DETAILED DESCRIPTION OF THE INVENTION

As discussed herein, various examples of the invention may be employed with a watch or other multipurpose device to control the operation of a digital media player. Digital media players include, for example, music players that play back sound files saved in any of a variety of formats, including MP3 files, ACC files, and WAV files. Depending upon the type of digital media player, these files may be stored on a magnetic storage medium, such as a magnetic hard disk drive, in an electronic memory circuit, such as a flash memory device, or in any other known storage media. With some examples of the invention, the sound files may be stored on an optical storage medium, such as a compact disc player. Still further, with some examples of the invention, the digital media player may additionally play back and display a video file, such as an MPEG file, display photos, play games, etc.

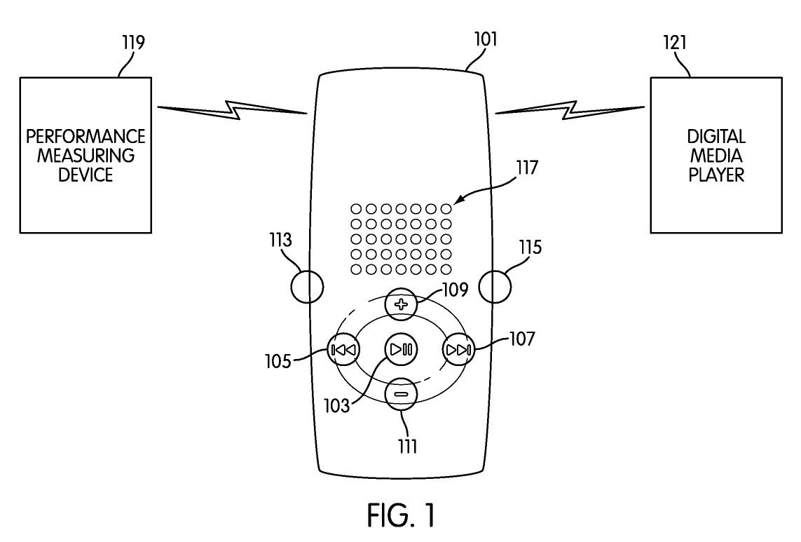

FIG. 1 illustrates a watch that may implement one or more aspects of the invention. As seen in FIG. 1, the watch may include five buttons on its face: a center button 103, a left face button 105, a right face button 107, an upper face button 109 a lower face button 111, a left side button 113, and a right side button 115. This button arrangement or a portion thereof (e.g., buttons 103-111) may correspond to a conventional button configuration on a digital media player. Buttons 105-111 may be disposed about a bezel of watch 101. In this configuration, the center face button 103 may correspond to a “PLAY” command, the left face button 105 may correspond to a “REWIND/PREVIOUS TRACK” command, the right face button 107 may correspond to a “FORWIND/NEXT TRACK” command, the upper face button 109 may correspond to a “VOLUME UP” command, and the lower face button 111 may correspond to a “VOLUME DOWN” command. In the illustrated example, watch 101 also has a pair of buttons on either side of its casing, referred to herein as left side button 113 and right side button 115, respectively. Watch 101 may also include a display area 117, e.g., an LCD display, dot matrix LEDs, or the like.

Watch 101 may wirelessly communicate with digital media player 121 based on button commands input by a user or wearer of watch 101. For example, when a user presses an initial button (e.g., any button), watch 101 may wirelessly “pair up” with digital media player 121.

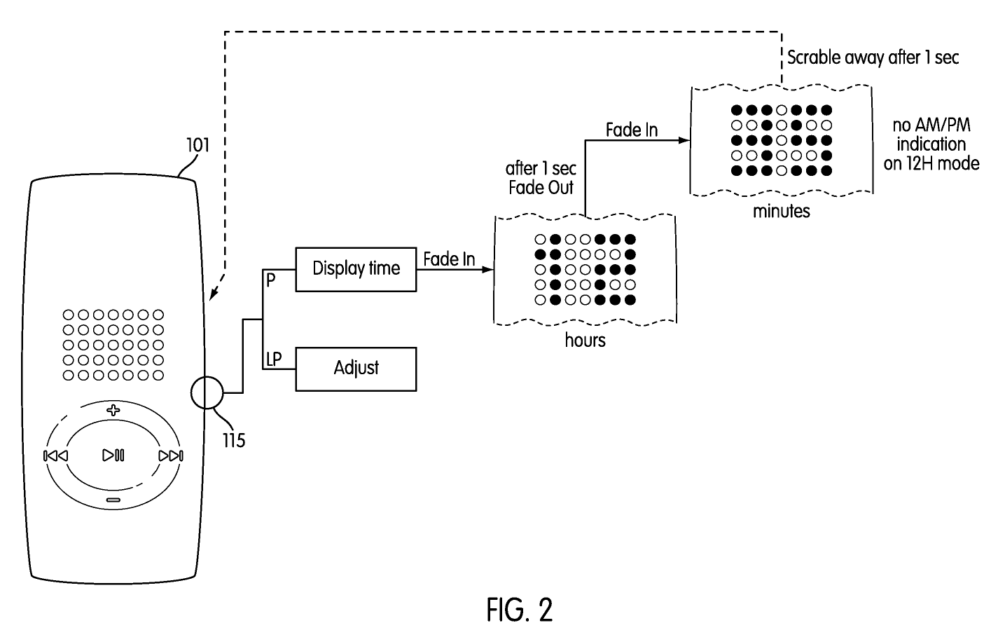

With reference to FIG. 2, depressing each button of watch 101 activates a function on either the watch, digital media player 121 communicating with the watch from a remote location, or both. As used in the figures, the abbreviation “P” indicates the action of briefly depressing a corresponding button, also referred to herein as a brief press. The abbreviation “LP” indicates the action of depressing the corresponding button and then holding that corresponding button in the depressed position for some threshold period of time, e.g., greater than 0.5 seconds, also referred to herein as a long press. Thus, in the illustrated example of FIG. 2, briefly depressing right side button 115 causes the watch to display its current time values, while depressing and holding (long press) right side button 115 causes the watch to initiate its adjust mode, allowing the user to adjust the current time values.

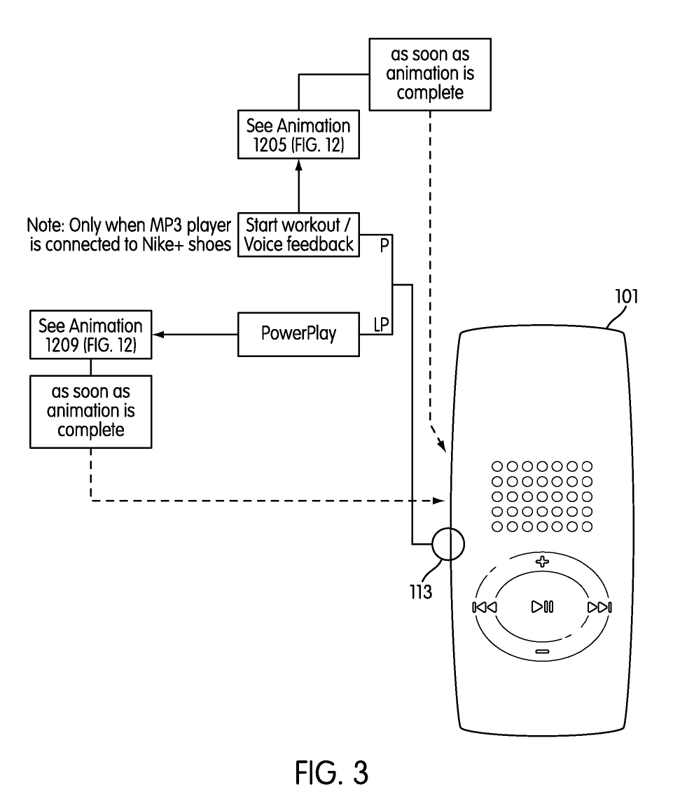

With reference to FIG. 3, the left side button 113 may perform functions associated with the remotely controlled digital media player. With various examples of the invention, the digital media player (or the watch) may be in communication with yet another device 119 that measures an activity performance parameter associated with the user. The activity performance parameter measurement device 119 may be a device that measures a biological performance parameter associated with the user, such as the user's heart rate or blood oxygen content. The activity performance measurement device 119 alternately or additionally may be a device that measures a physical performance parameter associated with the user, such as the distance traveled by a user, the user's speed, or a current position of the user. With these examples of the invention, when the user briefly depresses the left side button 113, the watch 101 may command the digital media player to audibly play back the value of the performance parameter most recently measured by the activity performance measurement device 119.

If, however the user depresses and holds left side button 113, then watch 101 may command the digital media player to enter a PowerPlay mode, where the digital media player plays back a specific sound file previously designated by the user. For example, a user may find a favorite song particularly inspirational when performing some type of physical activity such as running up a hill or lifting heavy weights. If the user feels the need to obtain extra inspirational encouragement, such as just before getting his or her second wind or at the final length of an arduous race, the user can depress and hold left side button 113 to cause the digital media player to begin playback of the previously designated song. Of course, in addition to an inspirational song, a user can designate left side button 113 to playback any desired sound file, such as a sound file containing inspirational words or a song useful to maintain a specific pace.

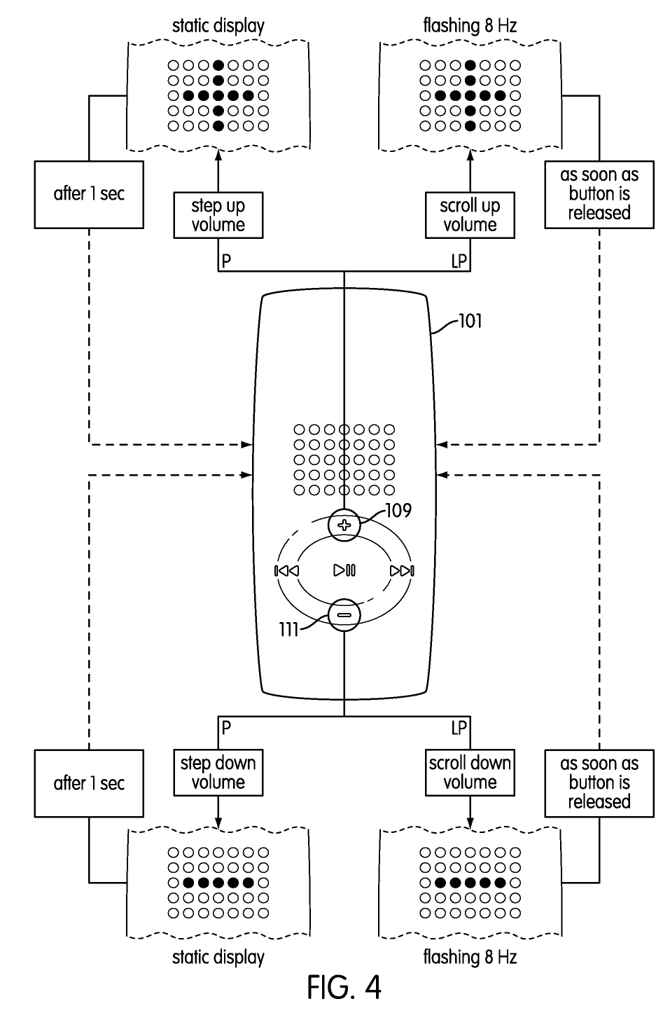

With reference to FIG. 4, top button 109 and bottom button 111 may be used to remotely adjust a volume level up and down, respectively, of the digital media player. When a user briefly presses top button 109, watch 101 sends a command to the digital media player to increase its volume one incremental step. When a user presses and holds top button 109, watch 101 sends a command to the digital media player to keep increasing its volume until top button 109 is released. When a user briefly presses bottom button 111, watch 101 sends a command to the digital media player to decrease its volume one incremental step. When a user presses and holds bottom button 111, watch 101 sends a command to the digital media player to keep decreasing its volume until bottom button 111 is released. As shown in FIG. 4, watch 101 may provide visual feedback based on each action.

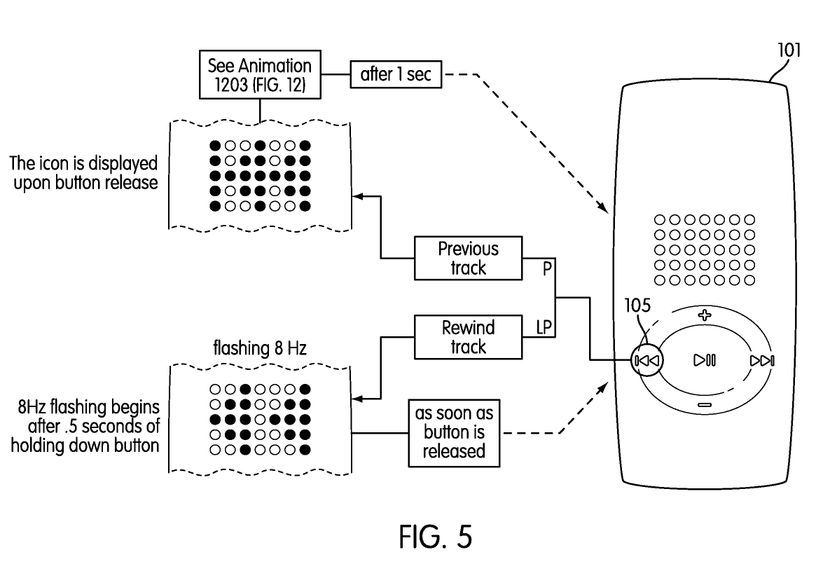

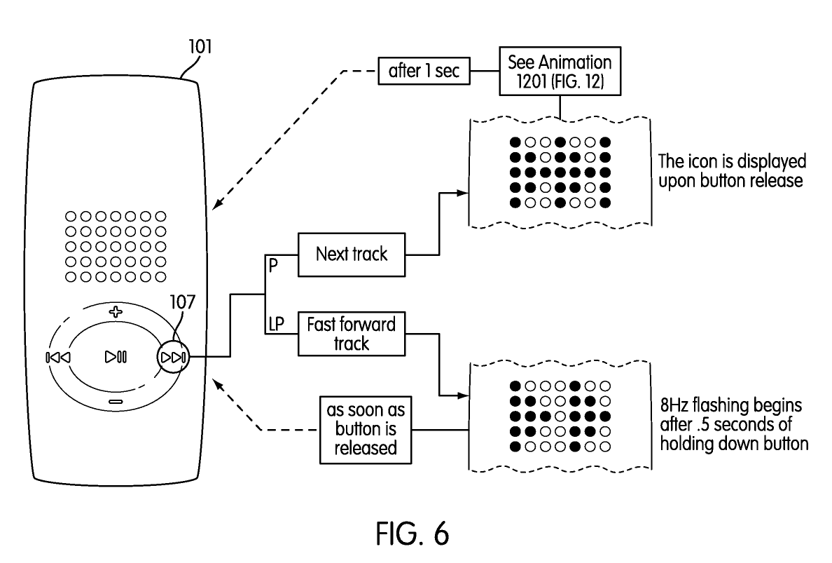

With reference to FIG. 5 and FIG. 6, left button 105 and right button 107, respectively, may be used to move backward and forward, respectively, audio playing on digital media player 121. When a user briefly presses left button 105, watch 101 sends a command to the digital media player to skip to a previous or prior audio file. When a user presses and holds left button 105, watch 101 sends a command to the digital media player to rewind a currently playing audio file. When a user briefly presses right button 107, watch 101 sends a command to the digital media player to skip to a next or subsequent audio file. When a user presses and holds right button 107, watch 101 sends a command to the digital media player to fast forward a currently playing audio file. As shown in FIG. 5 and FIG. 6, watch 101 may provide visual feedback based on each action.

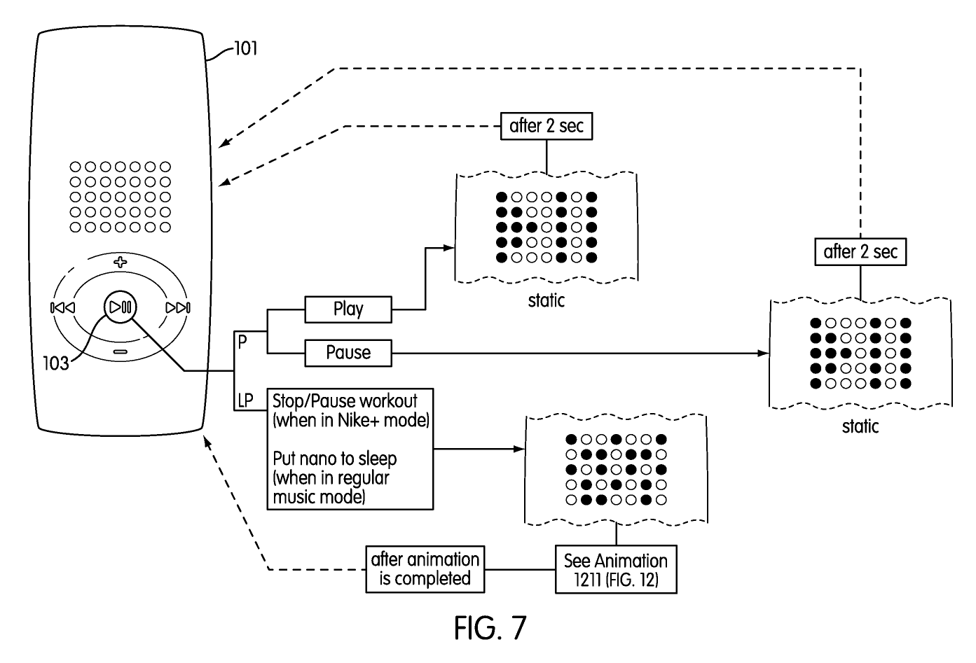

With reference to FIG. 7, center button 103 may be used to control start/stop operations of digital media player 121. For example, when a user briefly presses center button 103, watch 101 sends a play/pause toggle command to digital media player 121 to alter between a play and a pause state. When a user presses and holds center button 103, watch 101 sends a command to the digital media player to either stop/pause a workout (when in a special workout mode) or to power down (when not in the special workout mode). As shown in FIG. 7, watch 101 may provide visual feedback based on each action.

FIG. 1 illustrates display 117 in a default state, e.g., displaying no information. Each of FIGS. 2-7 illustrate display 117 providing visual feedback based on the action that watch 101 performs. The visual feedback may include a static display of a symbol, design, pattern, number or letter (collectively, icon), flashing icon, or an animated icon.

In an embodiment incorporating a speaker, audible feedback may be included as well, for example, to confirm button presses. Each of FIGS. 2-7 further indicates a wait period or other event associated with each action that, upon the occurrence of the event, display 117 returns to a default state.

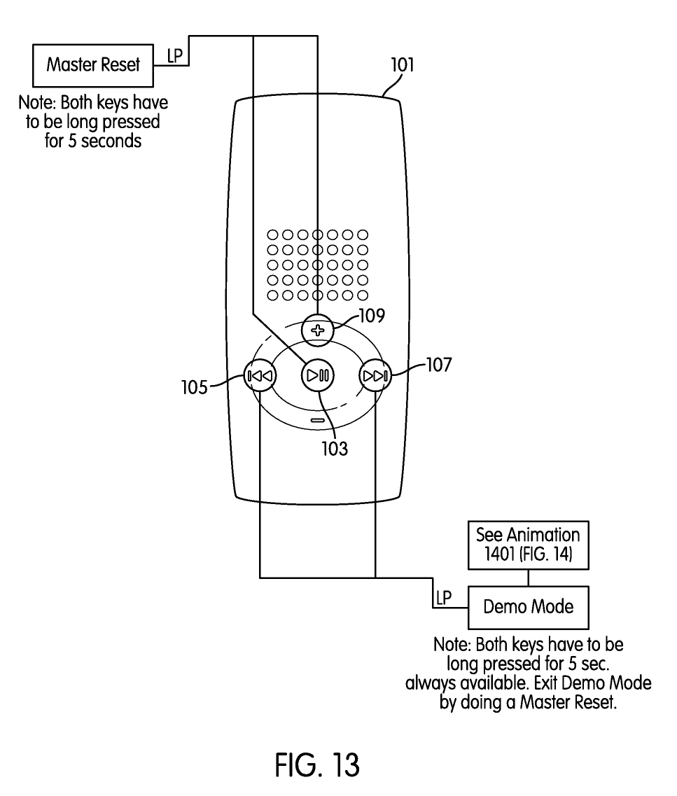

FIGS. 2-7 illustrate basic operations of an illustrative embodiment. If any button becomes stuck in a pressed position, watch 101 may send a clear signal after some predetermined period of time, e.g., 2 minutes. Watch 101 may require some predetermined minimum time lapse between button presses. That is, watch 101 may ignore a button press that follows less than the predetermined amount of time after a previous button press. According to an illustrative embodiment, multiple simultaneous button presses may be ignored, or may cause watch 101 to perform an additional function. For example, FIG. 13 illustrates that a demo mode may be entered by pressing a first button combination, e.g., buttons 105, 107, for some predetermined amount of time, e.g., >5. A master reset may be performed by pressing a second button combination, e.g., buttons 103, 109, for some predetermined amount of time, e.g., >5 secs. Other button combinations and/or predetermined amounts of time may be used.

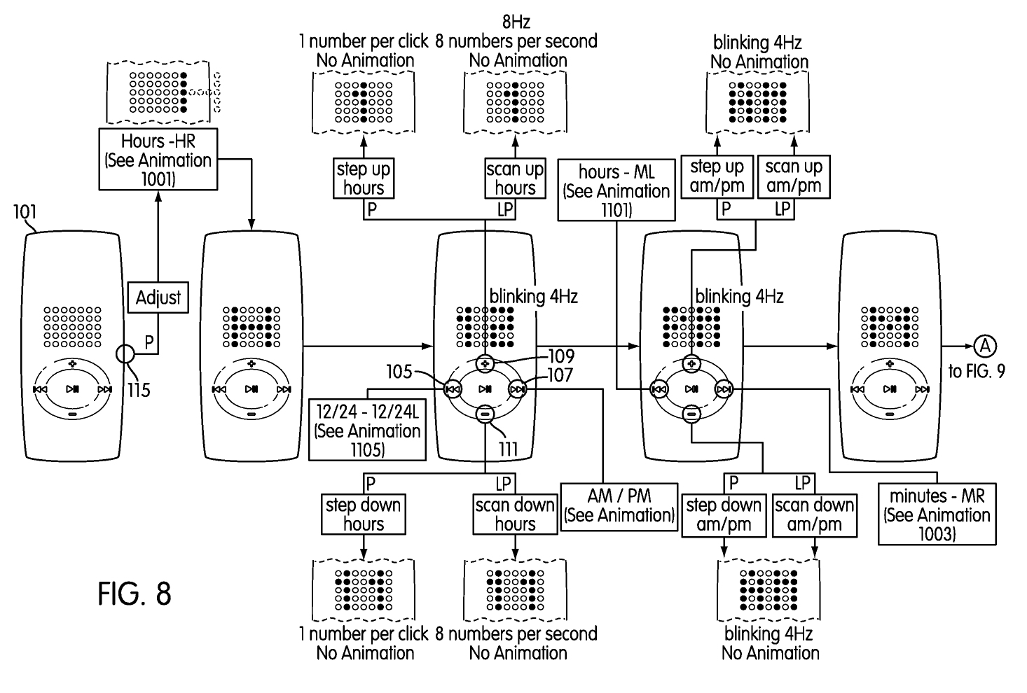

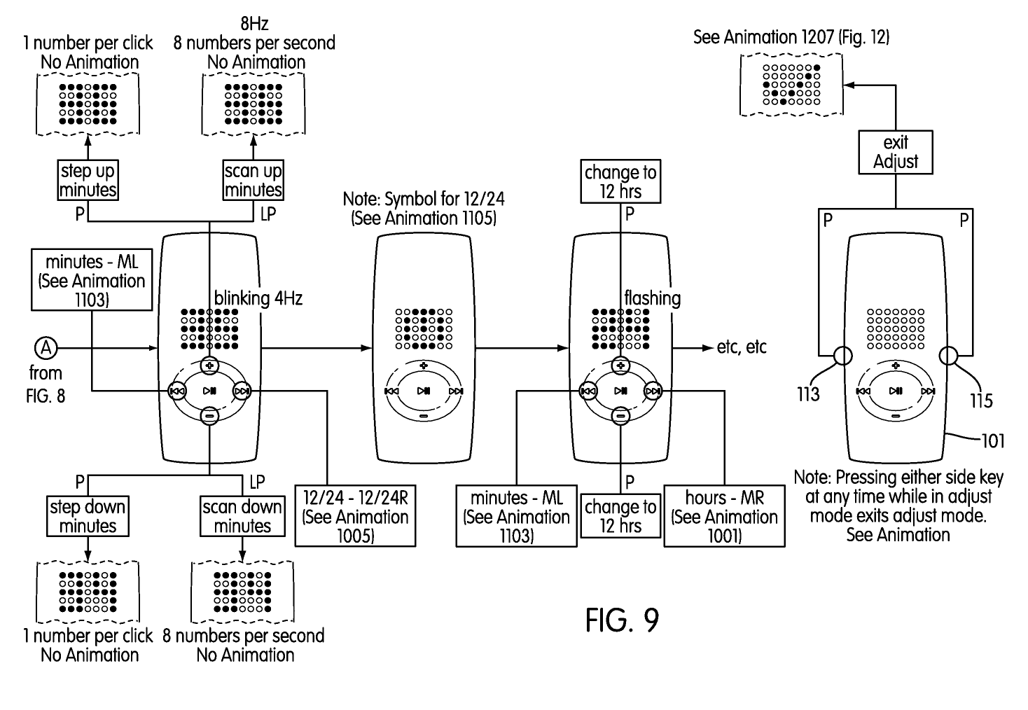

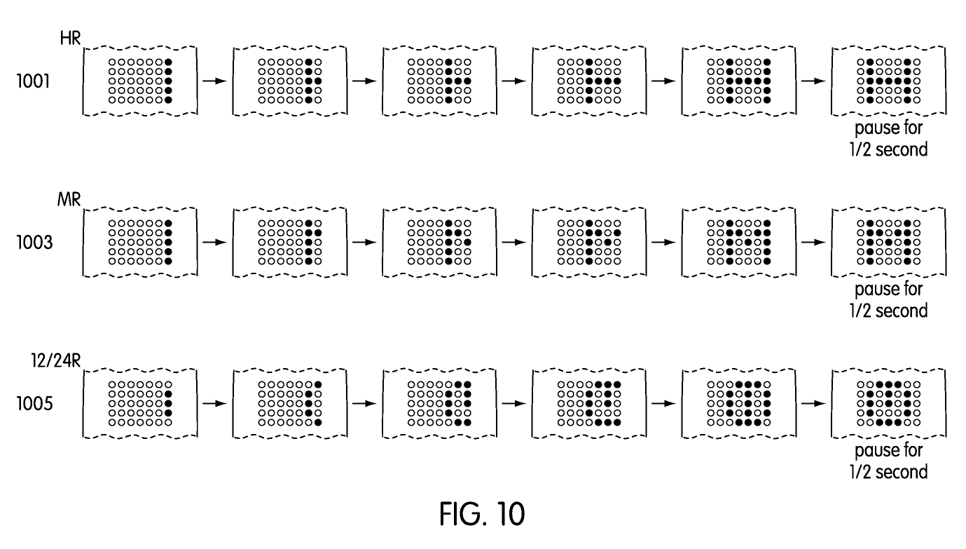

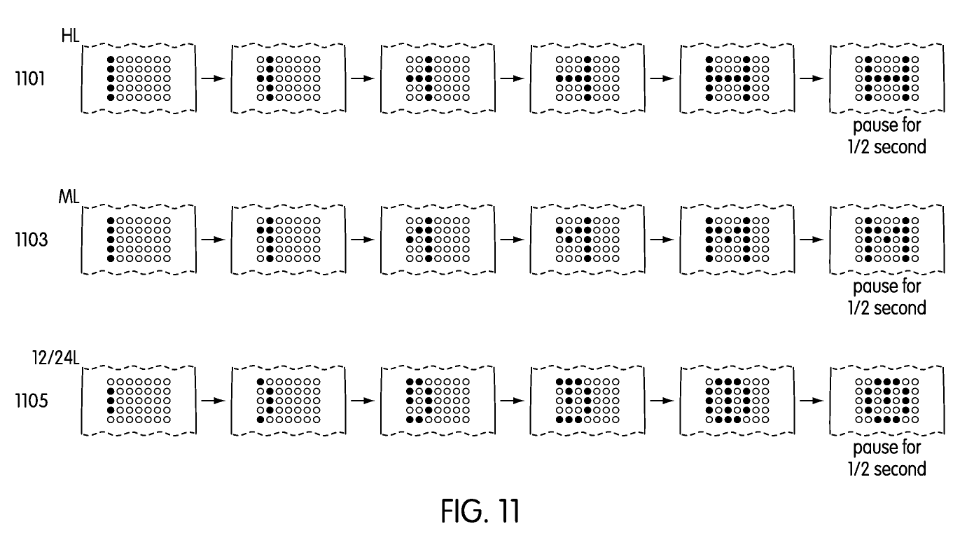

FIGS. 8-9 illustrate a control flow for adjusting the time values of watch 101. While in the time adjust mode, display 117 may remain in an always on state. After some predetermined amount of time of inactivity, e.g., 30 seconds, watch 101 may revert to a default mode (i.e., exit the time adjust mode) and return display 117 to a default state. FIGS. 10 and 11 illustrate animations 1001, 1003, 1005, 1101, 1103, 1005 that may be displayed by watch 101 on display 117 during various steps of the control flow illustrated in FIGS. 8-9. For example, upon entering time adjust mode by pressing and holding right side button 115 for some predetermined amount of time (e.g., >0.5 seconds), FIG. 8 indicates that the “Hours” icon “H” may be displayed in an animated manner according to animation 1001 (FIG. 10) before the user may adjust the hours. The remainder of FIGS. 8-9 also identify which of the animations shown in FIG. 10 and FIG. 11 correspond to each action while watch 101 is in the time adjust mode depicted FIGS. 8-9. The animations in FIG. 10 and FIG. 11 are similar, except that whereas in FIG. 10 the icons appear from the right, in FIG. 11 the icons appear from the left. In an alternative embodiment, the same animation may be used regardless of whether a left or right button triggered an action.

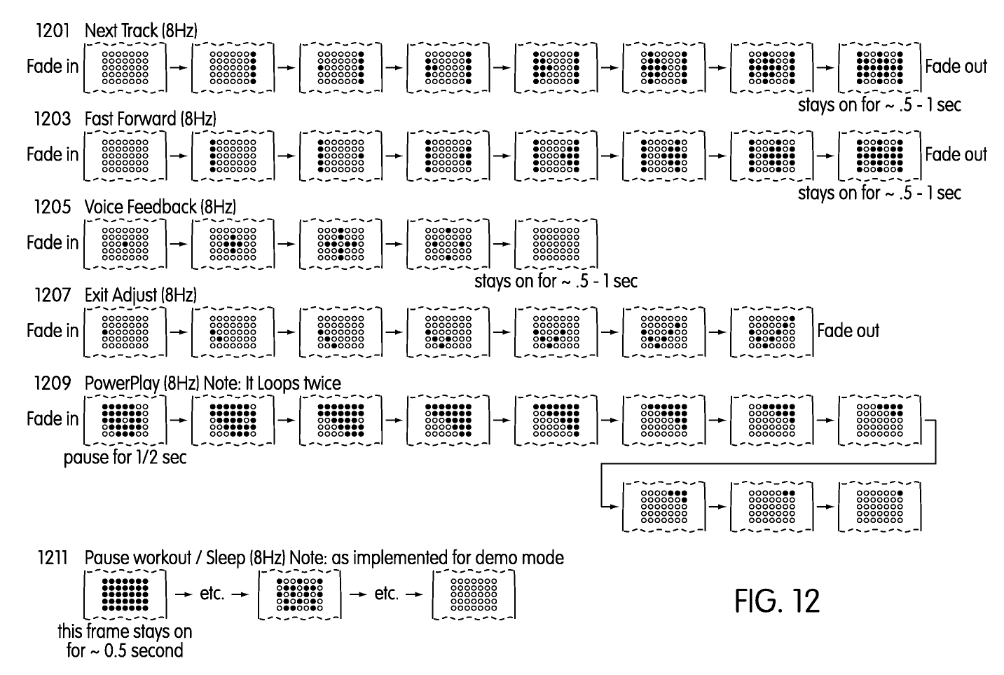

FIG. 12 similarly illustrates animations 1201, 1203, 1205, 1207, 1209, and 1211 that may be displayed by watch 101 on display 117 during various steps of the control flow illustrated in FIGS. 3-9. For example, watch 101 may display animation 1201 on display 117 when a user briefly presses button 107 from a default mode to skip to a next track. Watch 101 may display animation 1203 on display 117 when a user briefly presses button 105 from a default mode to skip to a previous track. Watch 101 may display animation 1205 on display 117 when a user briefly presses button 113 from a default mode to request voice feedback to audibly play back a value measured by the activity performance measurement device 1 19. Watch 101 may display animation 1207 on display 117 when a user simultaneously presses button 113 and button 115 to exit an adjust settings mode. Watch 101 may display animation 1209 on display 117 when a user presses and holds button 113 for a predetermined amount of time, e.g., >0.5 seconds, from a default mode to request the PowerPlay mode described above. Watch 101 may display animation 1211 on display 117 when a user presses and holds button 103 for a predetermined amount of time, e.g., >0.5 seconds, from a default mode to request that digital media player 121 either stop/pause a workout or put the digital media player in a power down mode (depending on the current mode of the digital media player, as discussed above).

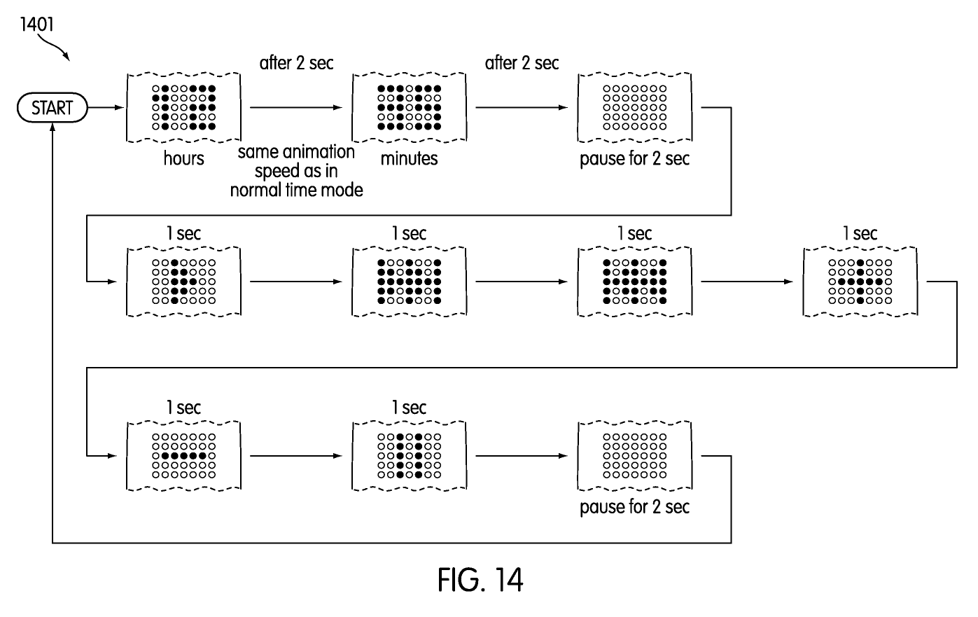

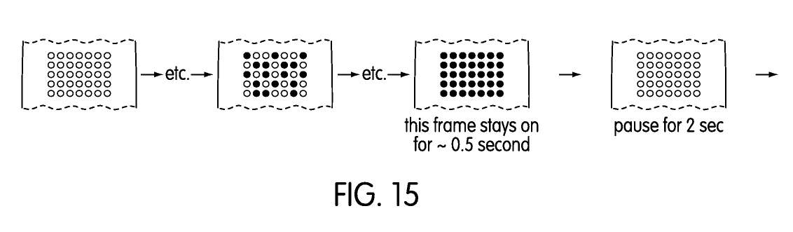

FIG. 14 illustrates a demo mode animation 1401 that may be displayed by watch 101 on display 117 as a result of a user pressing a button combination to enter a demo mode, e.g., as illustrated in FIG. 13. FIG. 15 illustrates a wake up animation sequence that watch 101 may display on display 117 when either watch 101 and/or digital media player 121 wakens from a power down mode.

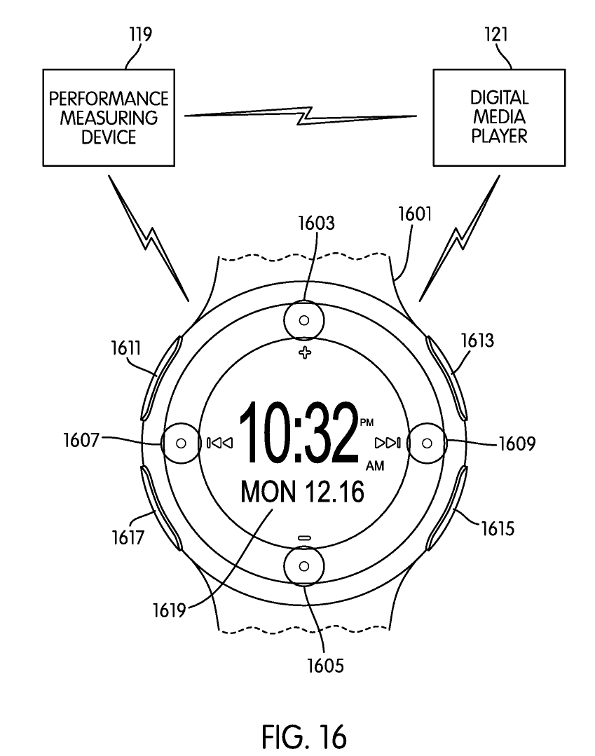

FIG. 16 illustrates a watch 1601 according to a second illustrative embodiment of the invention. Watch 1601 may include input buttons 1603, 1605, 1607, 1609, 1611, 1613, 1615, and 1617, and visual display 1619. Watch 1601 may wirelessly communicate with digital media player 121. Digital media player 121 and/or watch 1601 may be in further communication with performance measuring device 119. Buttons may be placed around a bezel of watch 1601, on one or more sides of watch 1601, on the face of watch 1601, or elsewhere as desired.

One or more buttons 1603-1617 may cause watch 1601 to send one or more commands to digital media player 121. In the presently illustrated embodiment, button 1617 may correspond to a “PLAY” command, button 1607 may correspond to a “REWIND/PREVIOUS TRACK” command, the button 1609 may correspond to a “FORWIND/NEXT TRACK” command, button 1603 may correspond to a “VOLUME UP” command, and button 1605 may correspond to a “VOLUME DOWN” command. Watch 101 may wirelessly communicate with digital media player 121 based on button commands input by a user or wearer of watch 101. For example, when a user presses an initial button (e.g., any button), watch 101 may wirelessly “pair up” with digital media player 121.

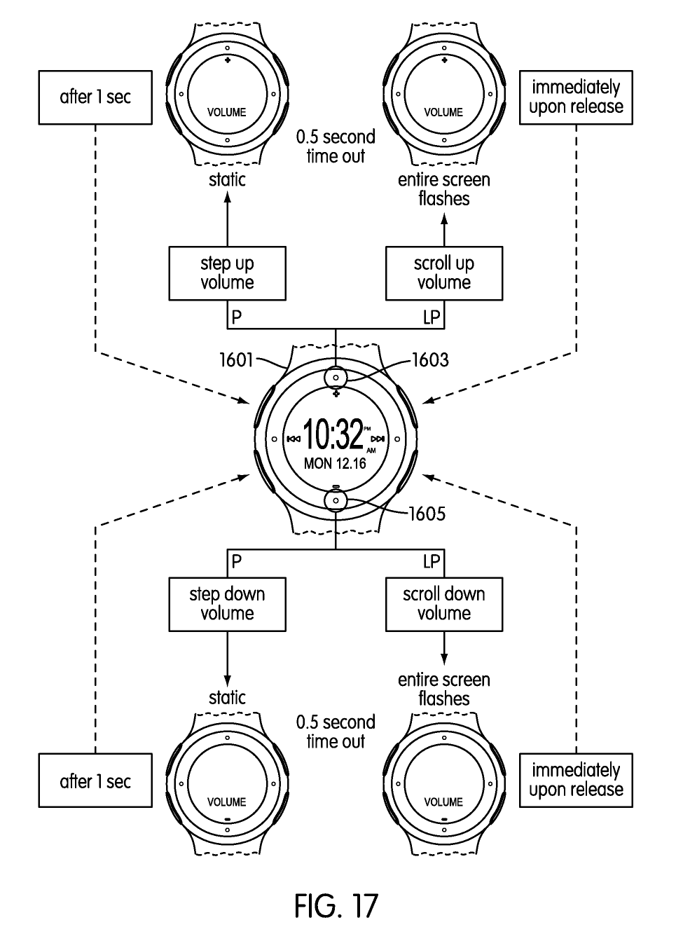

FIG. 17 illustrates a control flow for adjusting a volume level of digital media player 121 using watch 1601. Top button 1603 and bottom button 1605 may be used to remotely adjust a volume level up and down, respectively, of digital media player 121. When a user briefly presses top button 1603, watch 1601 sends a command to the digital media player to increase its volume one incremental step. When a user presses and holds top button 1603, watch 1601 sends a command to the digital media player to keep increasing its volume until top button 1603 is released. When a user briefly presses bottom button 1605, watch 1601sends a command to the digital media player to decrease its volume one incremental step. When a user presses and holds bottom button 1605, watch 1601 sends a command to the digital media player to keep decreasing its volume until bottom button 1605 is released. As shown in FIG. 17, watch 1601 may provide visual feedback based on each action.

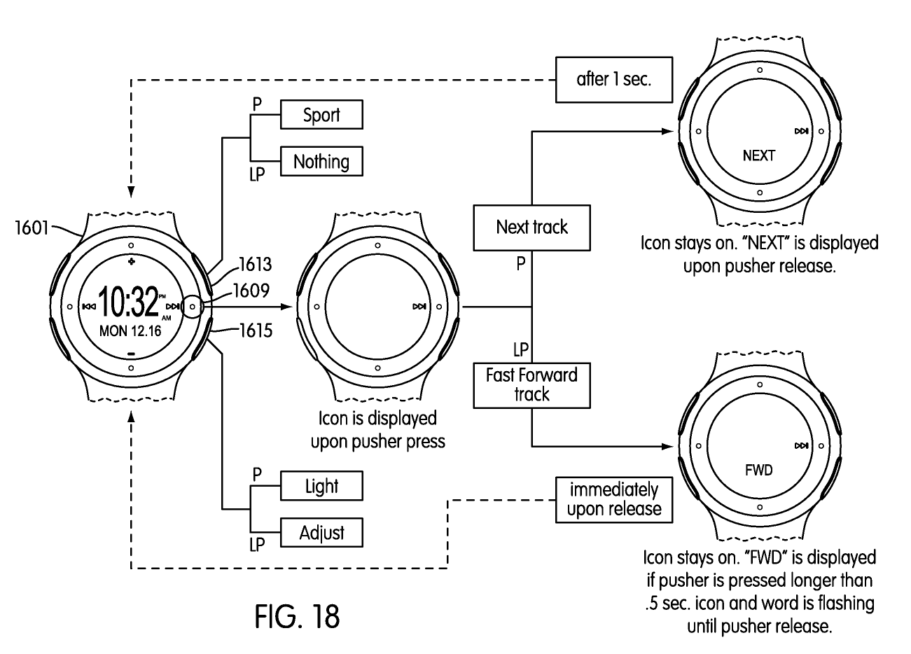

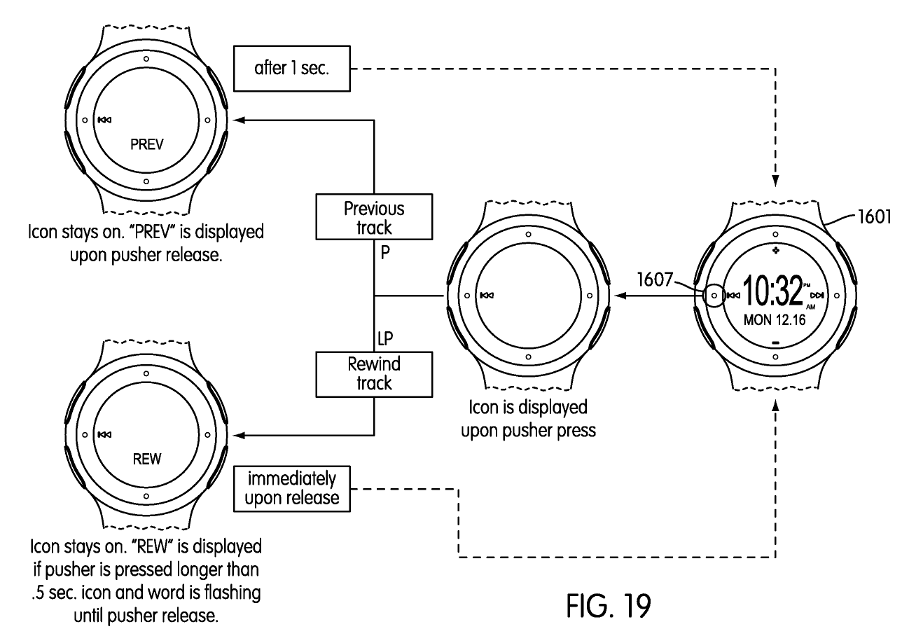

With reference to FIGS. 18 and 19, right button 1609 and left button 1607, respectively, may be used to move forward and backward, respectively, audio playing on digital media player 121. When a user briefly presses left button 1607, watch 1601 sends a command to the digital media player to skip to a previous or prior audio file. When a user presses and holds left button 1607, watch 1601 sends a command to the digital media player to rewind a currently playing audio file. When a user briefly presses right button 1609, watch 1601 sends a command to the digital media player to skip to a next or subsequent audio file. When a user presses and holds right button 1609, watch 1601 sends a command to the digital media player to fast forward a currently playing audio file. As shown in FIG. 18 and FIG. 19, watch 1601 may provide visual feedback based on each action.

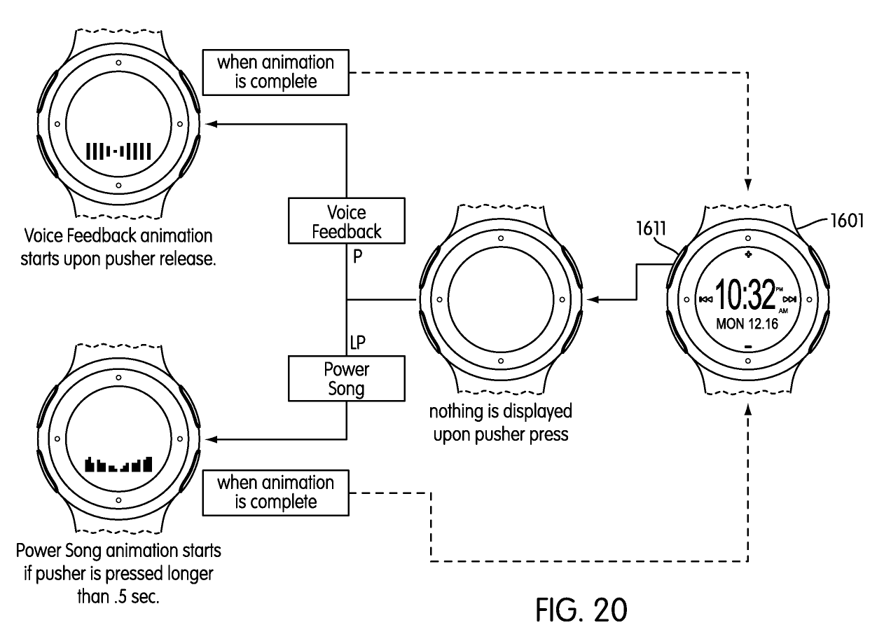

With reference to FIG. 20, when the user briefly depresses the northwest button 1611, watch 1601 may command the digital media player to audibly play back the value of a performance parameter most recently measured by activity performance measurement device 119. When the user depresses and holds northwest button 1611, then watch 1601 may command the digital media player to enter the PowerPlay mode described above. As indicated in FIG. 20, watch 1601 may provide visual feedback based on the action performed.

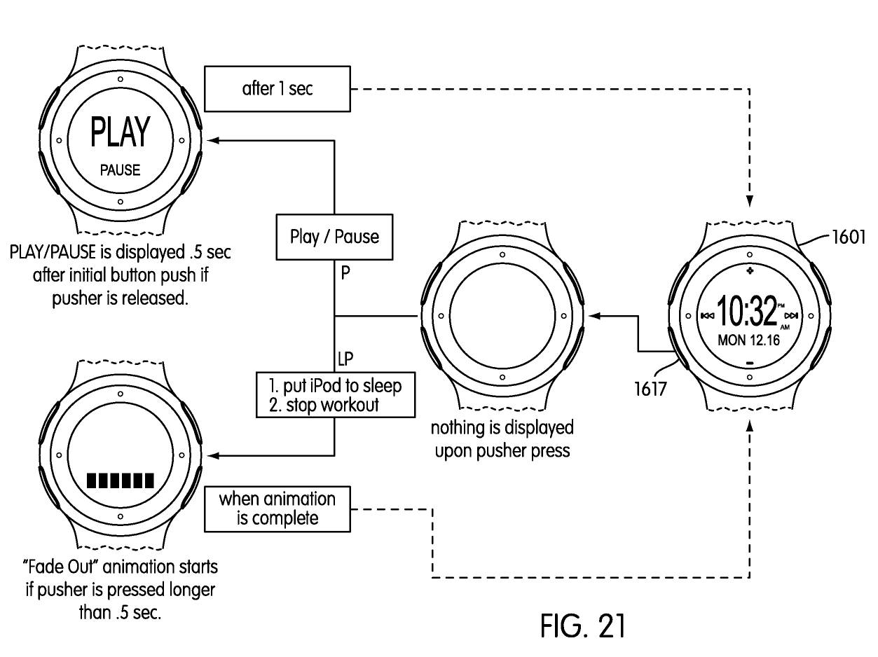

With reference to FIG. 21, southwest button 1617 may be used to control start/stop operations of digital media player 121. For example, when a user briefly presses southwest button 1617, watch 1601 sends a play/pause toggle command to digital media player 121 to alter between a play and a pause state. When a user presses and holds southwest button 1617, watch 1601 sends a command to the digital media player to either stop/pause a workout (when in a special workout mode) or to power down (when not in the special workout mode). As shown in FIG. 21, watch 1601 may provide visual feedback based on each action.

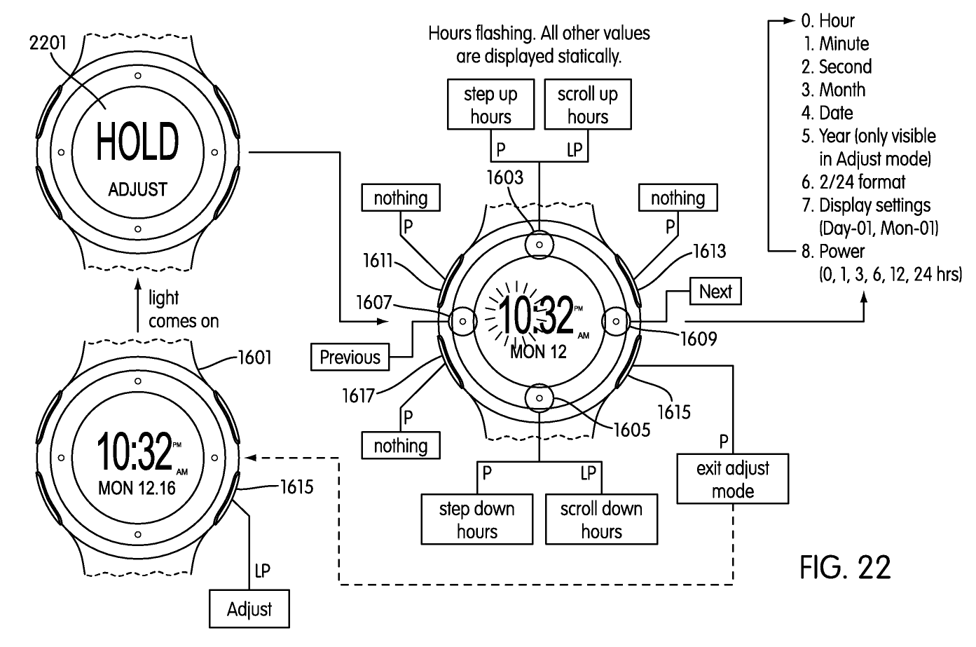

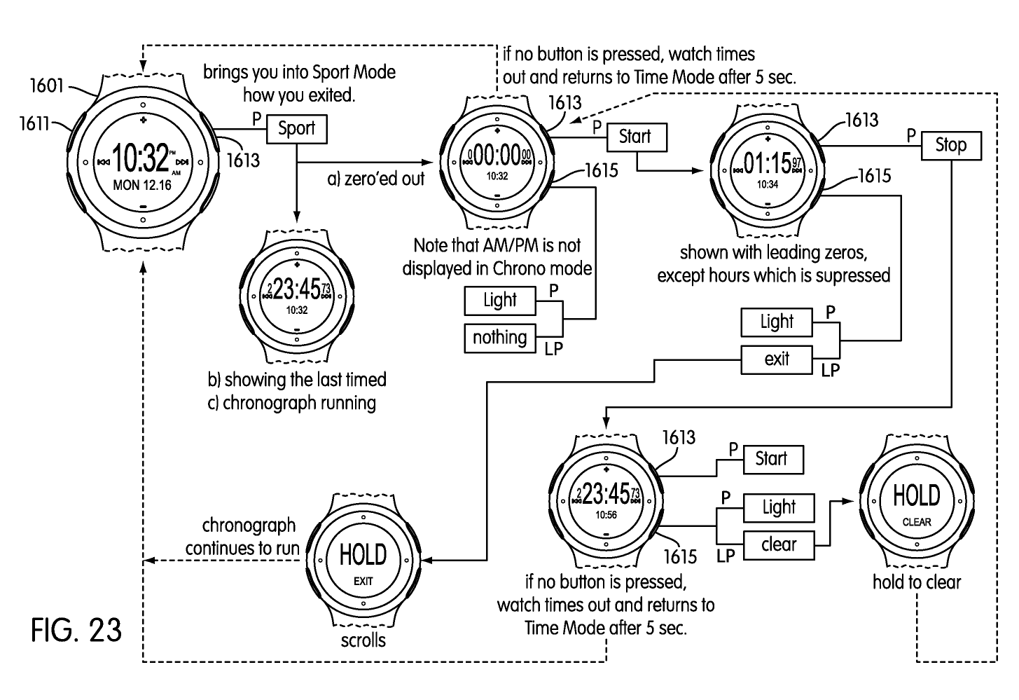

Again referring to FIG. 18, when a user presses northeast button 1613, watch 1601 may enter a sport mode, further discussed below with reference to FIG. 23. When a user briefly presses southeast button 1615, watch 1601 may illuminate a built in light for some predetermined period of time. When a user long presses, watch 1601 may enter an adjust mode, described with reference to FIG. 22.

FIG. 22 illustrates control flow of watch 1601 during an adjust mode, e.g., through which a user can alter settings of watch 1601. Initially, a user long presses southeast button 1615 to enter the adjust mode, and watch 1601 may provide visual feedback 2201 that watch 1601 is in adjust mode. Upon entering adjust mode, watch 1601 may present a first variable for adjustment, e.g., hours. While in the adjust mode, pressing button 1603 may step up a variable currently being adjusted, and long pressing button 1603 may scroll up a variable currently being adjusted. Pressing button 1605 may step down a variable currently being adjusted, and long pressing button 1605 may scroll down a variable currently being adjusted. According to one illustrative embodiment, watch 1601 may cycle through the variables: hours, minutes, seconds, month, day, year, 12/24 time format, display settings (Day-01, Mon-01), and power settings (e.g., power save mode after 0, 1, 3, 6, 12, 24 hours). A user can advance to a next variable or go backward to a previous variable using buttons 1607 and 1609. Pressing button 1609 may advance the variable being adjusted to a subsequent variable, whereas pressing button 1607 may change the variable being adjusted to a previous variable. Upon reaching the end of the variable list, watch 1601 may loop back to the first variable in the list.

FIG. 23 illustrates control flow of watch 1601 during a sport mode, e.g., that provides a chronograph feature. Initially, from a default mode, a user may long press button 1613 to cause watch 1601 to enter the sport mode. Once in the sport mode, pressing button 1613 may start and stop a chronograph displayed on watch 1601, and long pressing button 1615 may clear or reset the chronograph. Another button, e.g., button 1611, may provide a lap feature while watch 1601 is in sport mode.

The aforementioned embodiments are for illustrative purposes only. Modifications and variations may be made without departing from the scope of invention. For example, button functions may be swapped, removed, added, or otherwise changed. Watch 101, 1601 may directly communicate with performance measuring device 119 or may communicate with performance measuring device 119 indirectly through digital media player 121. Watch 101, 1601 and digital media player 121 preferably communicate wirelessly, e.g., using Bluetooth, RF, etc., however they may alternatively be directly connected via a cable. Some implementations may be used on a watch or similar alternately-purposed device configured to control a digital media player in addition to performing other functions.

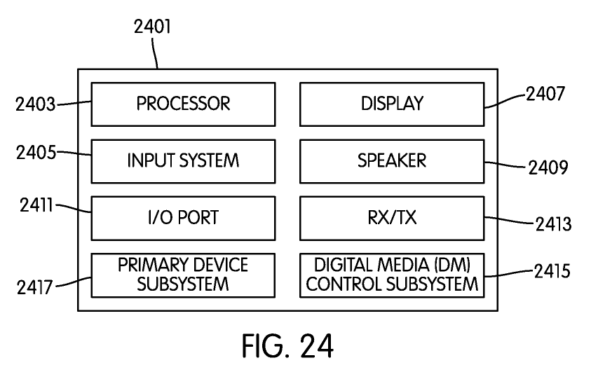

FIG. 24 illustrates a block hardware diagram of a device 2401 that may be used according to one or more aspects illustrated herein. Device 2401 may represent watch 101, watch 1601, or some other alternately-purposed device that is adapted to operate in conformance with one or more aspects described herein. Device 2401 may include a processor 2403 controlling overall operation of the device based on instructions stored in a primary subsystem 2417 and DM control subsystem 2415. Primary subsystem 2417 stores control logic to cause device 2401 to operate in conformance with a primary function, such as a watch function as is illustrated above, or may include functions for any other alternate-purpose device, e.g., scuba diving, mobile telephony, mobile communications, etc. Alternatively, device 2401 may be a special-purpose device that only controls a digital media player as described herein. Digital media control subsystem 2415 stores control logic to cause device 2401 to operate in conformance with one or more aspects described herein. Subsystems 2415 and 2417 may include volatile and/or nonvolatile memory, as needed.

Device 2401 may further include input system 2405, display 2407, speaker 2409, I/O data port 2411, and transceiver 2413. Input system 2405 may include multiple input buttons such as buttons 103-115 and/or button 1603-1617. Input buttons may include physical buttons, soft buttons, switches, levers, toggles, or any other actuatable device or system. Input system, 2405 may further include a microphone for voice recognition. Display 2407 may include an LCD display such as is illustrated in FIGS. 16-23, and/or a dot matrix LED display such as is illustrated in FIGS. 1-15. Any other type of known display may alternatively be used. Speaker 2409 may provide audio feedback based on actions/functions of device 2401, e.g., button confirmation clicks, alarms based on the biological performance parameter meeting predefined criteria (alarms may alternately be implemented in the digital media player to play the alarm through a headset worn by the user). Device 2401 may use a communication port to communicate with digital media player 121 (not shown). For example, I/O 2411 may be used to provide a direct cable connection between device 2401 and digital media player 121 (not shown). Alternatively (or in addition) device 2401 may primarily communicate with digital media player 121 (not shown) via transceiver 2413, such as a Bluetooth transceiver, RF transceiver, home band radio transceiver, or the like.

Control logic may be embodied in computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the control logic may be embodied in whole or in part in firmware or hardware equivalents such as integrated circuits, field programmable gate arrays (FPGA), and the like. Particular data structures may be used to more effectively implement one or more aspects of the invention, and such data structures are contemplated within the scope of computer executable instructions and computer-usable data described herein.

While the invention has been described with respect to specific examples including presently preferred modes of carrying out the invention, those skilled in the art will appreciate that there are numerous variations and permutations of the above described systems and techniques that fall within the spirit and scope of the invention as set forth herein.

What is claimed is:

1. A device, comprising:
a device housing configured to be worn by a human user;
a display providing visual output of the device;
an input subsystem comprising a plurality of input buttons;
a transceiver for communicating with a digital media player based on input received from a user via the plurality of buttons;
a processor for controlling overall operation of the device based on control logic defining digital media control functions of the device, said control logic comprising:
upon detecting a brief press of a first button of the plurality of input buttons, sending a play/pause toggle command to the digital media player,
upon detecting a brief press of a second button of the plurality of input buttons, sending a command to the digital media player to skip to a next audio file,
upon detecting a long press of the second button, sending a command to the digital media player to fast forward a currently playing audio file,
upon detecting a brief press of a third button of the plurality of input buttons, sending a command to the digital media player to skip to a previous audio file,
upon detecting a long press of the third button, sending a command to the digital media player to rewind a currently playing audio file,
upon detecting a brief press of a fourth button of the plurality of input buttons, sending a command to the digital media player to increment a volume up one step,
upon detecting a long press of the fourth button, sending a command to the digital media player to scroll volume up while the fourth button remains in a depressed state,
upon detecting a brief press of a fifth button of the plurality of input buttons, sending a command to the digital media player to decrement a volume down one step, and
upon detecting a long press of the fifth button, sending a command to the digital media player to scroll volume down while the fifth button remains in a depressed state.

2. The device of claim 1, wherein said control logic further comprises:
upon detecting a long press of a sixth button of the plurality of input buttons, sending a command to the digital media player to play a corresponding audio file previously identified by the user.

3. The device of claim 1, wherein said device comprises a wristwatch, and wherein said control logic further comprises: upon detecting a brief press of a sixth button of the plurality of input buttons, displaying a current time on the display.

4. The device of claim 3, wherein said control logic further comprises fading out the displayed time after a predetermined amount of time.

5. The device of claim 1, wherein said display comprises a dot matrix array of light emitting diodes (LEDs).

6. The device of claim 1, wherein said control logic further comprises a plurality of animation sequences for output on the display, each animation based on an action performed by the device.

7. The device of claim 6, wherein a first animation animates an icon from a left side of the display, and wherein a second animation animates the icon from a right side of the display, and a selection of the first and second animation is based on a location of an animation initiating button being located on a left or right side of the device.

8. The device of claim 3, wherein said housing comprises a bezel,
wherein said first button is centrally located within the bezel,
wherein said second button is located on a right portion of the bezel,
wherein said third button is located on a left portion of the bezel,
wherein said fourth button is located on an upper portion of the bezel, and
wherein said fifth button is located on a lower portion of the bezel.

9. The device of claim 3, wherein said housing comprises a bezel, and wherein said display is located above said bezel.

10. The device of claim 1, wherein said control logic further comprises, upon detecting a brief press of a sixth button of the plurality of input buttons, sending a command to a remote device to audibly play back a measured biological performance parameter associated with the user.

11. A method, comprising:
on a device comprising a device housing configured to be worn by a human user, a display providing visual output of the device, an input subsystem comprising a plurality of input buttons, a transceiver for communicating with a digital media player based on input received from a user via the plurality of buttons, and a processor for controlling overall operation of the device based on stored control logic, responsive to detecting a brief press of a first button of the plurality of input buttons, sending a play/pause toggle command to the digital media player;
responsive to detecting a brief press of a second button of the plurality of input buttons, sending a command to the digital media player to skip to a next audio file;
responsive to detecting a long press of the second button, sending a command to the digital media player to fast forward a currently playing audio file;
responsive to detecting a brief press of a third button of the plurality of input buttons, sending a command to the digital media player to skip to a previous audio file;
responsive to detecting a long press of the third button, sending a command to the digital media player to rewind a currently playing audio file;
responsive to detecting a brief press of a fourth button of the plurality of input buttons, sending a command to the digital media player to increment a volume up one step;
responsive to detecting a long press of the fourth button, sending a command to the digital media player to scroll volume up while the fourth button remains in a depressed state;
responsive to detecting a brief press of a fifth button of the plurality of input buttons, sending a command to the digital media player to decrement a volume down one step; and
responsive to detecting a long press of the fifth button, sending a command to the digital media player to scroll volume down while the fifth button remains in a depressed state.

12. The method of claim 11, further comprising, responsive to detecting a long press of a sixth button of the plurality of input buttons, sending a command to the digital media player to play a corresponding audio file previously identified by the user.

13. The method of claim 11, wherein said device comprises a wristwatch, and wherein said method further comprises, responsive to detecting a brief press of a sixth button of the plurality of input buttons, displaying a current time on the display.

14. The method of claim 13, further comprising fading out the displayed time after a predetermined amount of time.

15. The method of claim 11, wherein said fading comprises fading out a dot matrix array of light emitting diodes (LEDs).

16. The method of claim 11, further comprising selecting one of a plurality of animation sequences for output on the display based on an action performed by the device.

17. The method of claim 16, wherein a first animation animates an icon from a left side of the display, and wherein a second animation animates the icon from a right side of the display, and a selection of the first and second animation is based on a location of an animation initiating button being located on a left or right side of the device.

18. The method of claim 13, wherein said device housing comprises a bezel,
wherein said first button is centrally located within the bezel,
wherein said second button is located on a right portion of the bezel,
wherein said third button is located on a left portion of the bezel,
wherein said fourth button is located on an upper portion of the bezel, and
wherein said fifth button is located on a lower portion of the bezel.

19. The method of claim 13, wherein said device housing comprises a bezel, and wherein said display is located above said bezel.

20. The method of claim 11, further comprising, responsive to detecting a brief press of a sixth button of the plurality of input buttons, sending a command to a remote device to audibly play back a measured biological performance parameter associated with the user.

21. A watch, comprising:
a housing configured to substantially encircle a human wrist in a manner to secure the watch to the human wrist;
a display providing visual output of the watch;
an input subsystem comprising a plurality of input buttons;
a transceiver for communicating with a digital media player based on input received from a user via the plurality of buttons;
a processor for controlling overall operation of the watch based on control logic defining digital media control functions of the watch, said control logic comprising:
upon detecting a brief press of a first button of the plurality of input buttons, sending a play/pause toggle command to the digital media player,
upon detecting a brief press of a second button of the plurality of input buttons, sending a command to the digital media player to skip to a next audio file,
upon detecting a long press of the second button, sending a command to the digital media player to fast forward a currently playing audio file,
upon detecting a brief press of a third button of the plurality of input buttons, sending a command to the digital media player to skip to a previous audio file,
upon detecting a long press of the third button, sending a command to the digital media player to rewind a currently playing audio file,
upon detecting a brief press of a fourth button of the plurality of input buttons, sending a command to the digital media player to increment a volume up one step,
upon detecting a long press of the fourth button, sending a command to the digital media player to scroll volume up while the fourth button remains in a depressed state,
upon detecting a brief press of a fifth button of the plurality of input buttons, sending a command to the digital media player to decrement a volume down one step,
upon detecting a long press of the fifth button, sending a command to the digital media player to scroll volume down while the fifth button remains in a depressed state,
upon detecting a long press of a sixth button of the plurality of input buttons, sending a command to the digital media player to play a corresponding audio file previously identified by the user, and
upon detecting a brief press of a seventh button of the plurality of input buttons, displaying a current time on the display;
wherein said second button is proximately located near a right portion of a bezel of the watch;
wherein said third button is proximately located near a left portion of the bezel of the watch;
wherein said fourth button is proximately located near a top portion of the bezel of the watch;
wherein said fifth button is proximately located near a lower portion of the bezel of the watch;
wherein said sixth button is proximately located on a first side of the watch; and
wherein said seventh button is proximately located on an opposite side of the watch from said sixth button.
